(19) United States
(12) Patent Application Publication
(10) Pub. No.: US 2009/0181215 A1
(43) Pub. Date: Jul. 16, 2009

(54) PLASTIC CARD AND METHOD FOR MAKING A PLASTIC CARD

(75) Inventors: LAWRENCE J. KEIM, Lakeland, FL (US); ROBERT W. SINGLETON, Lakeland, FL (US)

Correspondence Address: FOLEY AND LARDNER LLP;SUITE 500, 3000 K STREET NW, WASHINGTON, DC, 20007, US

(73) Assignee: INNOVATIER, INC.

(21) Appl. No.: 12/014,412

(22) Filed: Jan. 15, 2008

(51) Int. Cl. B32B 3/30; B29C 45/14; B32B 27/00; B29C 45/16

(52) U.S. Cl. 428/161; 428/411.1; 428/412; 428/480; 428/522; 428/704; 428/172; 428/175; 264/261; 264/138; 264/258

(57) ABSTRACT

A plastic card, including a bottom overlay, a top overlay positioned above a top surface of the bottom overlay and a core layer positioned between the top surface of the bottom overlay and the top overlay. A method for manufacturing a plastic card, including loading a bottom overlay into an injection molding apparatus, loading a top overlay into the injection molding apparatus wherein the top overlay is positioned above a top surface of the bottom overlay and injecting a core layer between the bottom overlay and top overlay, wherein one or more protrusions are formed on the surface of the top overlay. The protrusions may be arranged in such a way as to form designs on the surface of the plastic card.

### BACKGROUND

The following description of the background of the invention is provided simply as an aid in understanding the invention and is not admitted to describe or constitute prior art to the invention.

Generally, plastic cards are used as credit cards, bankcards, ID cards, telephone cards, security cards, tokens or similar devices. Plastic cards are generally constructed by assembling several layers of plastic sheets in a sandwich array. Conventional methods of manufacture allow for these cards to be made from a limited amount of materials and shapes.

In view of the following, there is a need for a plastic card and method of making a plastic card that can be made of various materials and in various shapes for a wide range of commercial purposes.

### SUMMARY OF THE INVENTION

According to one embodiment, a plastic card, includes a bottom overlay, a top overlay positioned above a top surface of the bottom overlay, wherein the top overlay has one or more protrusions and a core layer positioned between the top surface of the bottom overlay and the top overlay.

According to another embodiment, a method for manufacturing a plastic card, includes loading a bottom overlay into an injection molding apparatus, loading a top overlay into the injection molding apparatus wherein the top overlay is positioned above a top surface of the bottom overlay and injecting a core layer between the bottom overlay and top overlay, wherein one or more protrusions are formed on the surface of the top overlay.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a sectional view of a plastic card according to one embodiment of the present invention.

FIG. 2 is a sectional view of a plastic card according to one embodiment of the present invention with different proportionate heights.

FIG. 3 is a sectional view of a plastic card and an injection nozzle according to one embodiment of the present invention.

FIG. 4 is a top view of a series of plastic cards formed on one molded sheet according to one embodiment of the present invention.

### DETAILED DESCRIPTION

Embodiments of the present invention will be described below with reference to the accompanying drawings. It should be understood that the following description is intended to describe exemplary embodiments of the invention, and not to limit the invention.

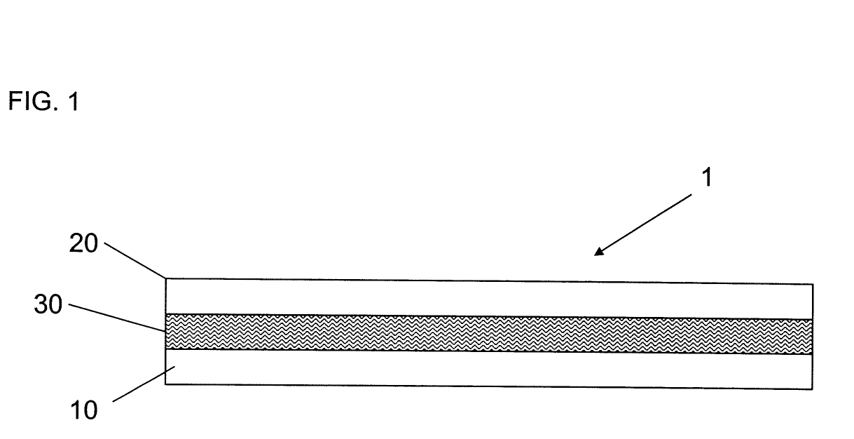

According to one embodiment of the present invention, as shown in FIG. 1, a plastic card 1 comprises a printed bottom overlay 10, a top overlay 20 and a core layer 30.

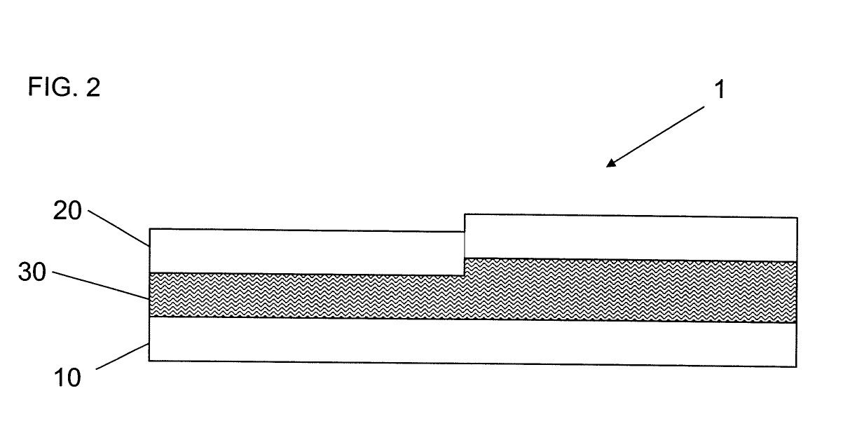

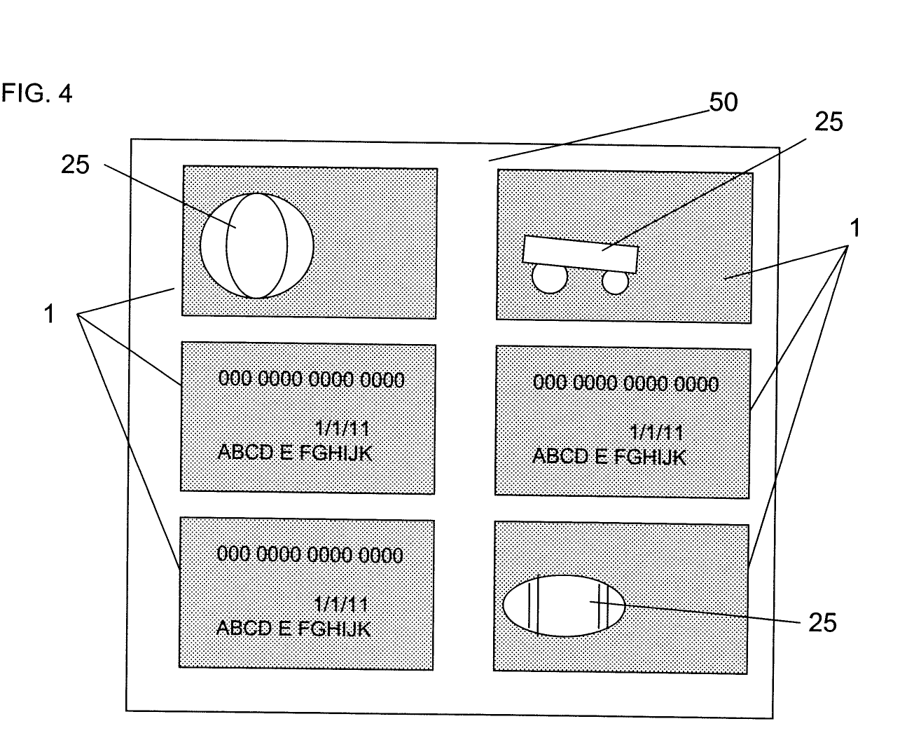

According to another embodiment, as shown in FIG. 2, a plastic card 1 comprises a bottom overlay 10, a top overlay 20, a core layer 30. In this embodiment, the plastic card 1 has at least two portions of different thicknesses. The plastic card 1 may be designed to have different thicknesses to obtain a certain look and feel. The bottom and/or top overlay may have one or more protrusions 25 (FIG. 4) which may be formed into various shapes. For example, if the plastic card 1 is being used for a purpose related to a sporting event, the card may be configured with protrusions 25 (FIG. 4) and varying thicknesses to mimic shapes related to the sporting event, e.g. a ball on the card surface, the face of a team mascot, etc. In addition, the top layer may be configured with raised lettering. FIG. 4 is a sectional view of a series of plastic cards 1 formed on one molded sheet 50 according to one embodiment of the present invention.

The bottom overlay 10 may be comprised of any suitable material dense enough to prohibit the core layer from penetrating through the bottom overlay. For example, the bottom overlay may be comprised of polycarbonate, polyvinyl chloride (PVC), polyethylene terephtalate (PET), polyethylene terephtalate glycol (PETG) or like material. Further, numerous other materials may be used to form the bottom overlay 10 including but not limited to fabric, plastic, metal, etc. For example, the bottom overlay 10 may be formed from denim fabric. Printed information may be placed on either the inside or outside surface of the bottom overlay 10. For example, the bottom overlay 10 may include printed information consistent with a standard credit card or identification tag, including a name, expiration date and account number. According to another embodiment of the invention, the bottom overlay 10 may be clear or ⅖ clear/white printed. Specifically, a 0.002 inch thick piece of clear PVC material is laminated on to a layer of white PVC that is 0.005 inches in thickness.

A top overlay 20 positioned above the top surface of the bottom overlay 10 is shown in FIGS. 1-3. The top overlay 20 may be comprised of any suitable material dense enough to prohibit core layer from penetrating through the top overlay. For example, the top overlay may be comprised of polycarbonate, polyvinyl chloride (PVC), Polyethylene Terephtalate (PET), Polyethylene Terephtalate Glycol (PETG) or like material. Further, numerous other materials may be used to form the top overlay 20 including but not limited to fabric, plastic, metal, wood, stone, etc. For example, the top overlay 20 may be formed from denim fabric. According to one embodiment of the invention, the surface of the top overlay 20 in contact with the core layer 30 has printed information. Alternatively, the inside or outside surface of the top overlay 20 may have printed information. For example, the top overlay 20 may include printed information consistent with a standard credit card or identification tag, including a name, expiration date and account number. According to another embodiment of the invention, the top overlay 20 may be clear or “⅖ clear/white printed.”

As shown in FIG. 1, a core layer 30 is positioned between the top surface of bottom overlay 10 and the top overlay 20. The core layer may be composed of any thermosetting material. Preferably, the core layer 30 is composed of a thermosetting polymeric material. For example, the core layer 30 may be composed of polyurea.

Polyurea is a known elastomer that is derived from the reaction product of an isocyanate component and a resin blend component. See What is polyurea? THE polyurea development association, at http://www.pda-online.org/pda_resources/whatispoly.asp (last visited Nov. 2, 2007). According to one embodiment the material used to form the bottom and top overlay may vary.

Polyurea has numerous advantages over other conventional materials currently being used in similar applications. Polyurea has a high resistance to UV light. In addition, polyurea has low elasticity and elongation characteristics. This enables the plastic card 1 to remain rigid. Further, polyurea has high bonding properties, allowing it to effectively bond to the top and bottom overlays 10, 20. The plastic card 1 also possess desirable environmental characteristics due to polyurea's low moisture absorption and stability at high temperatures.

A method for manufacturing a plastic card 1 according to the present invention will now be described.

The printed bottom overlay 10 is loaded into an injection molding apparatus. A printed top overlay 20 is placed into the injection molding apparatus and positioned such that the top overlay 20 is above the top surface of the bottom overlay 10. Specifically, the injection molding apparatus may be a reaction injection molding machine (“which is often individually referred to as “RIM”). These machines are associated with a top mold shell and a bottom mold shell that are capable of performing cold, low pressure, forming operations on at least one of the sheets of polymeric material (e.g., PVC) that make up the top 20 and bottom 10 overlay. Such top and bottom mold shells cooperate in ways that are well known to those skilled in the polymeric material molding arts.

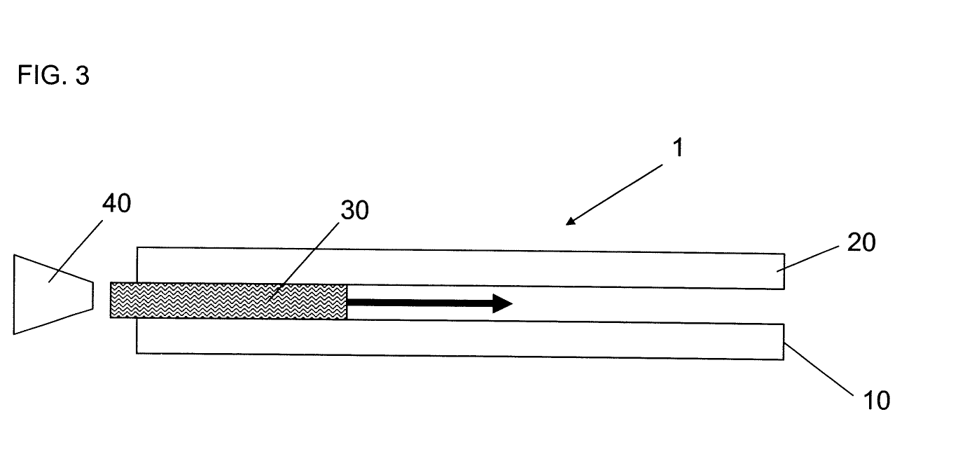

The injection molding apparatus then injects thermosetting polymeric material via a nozzle 40 (shown in FIG. 3) between the top overlay 20 and the bottom overlay 10 forming the core layer 30 from thermosetting polymeric material. Preferably, as mentioned above, the thermosetting polymeric material is polyurea.

Cold, low pressure forming conditions generally mean forming conditions wherein the temperature of the core layer 30 consisting of thermosetting polymeric material, is less than the heat distortion temperature of the top 20 and bottom 10 overlays, and the pressure is less than about 500 psi.

According to one embodiment of the invention, the more preferred cold, low pressure forming procedures will involve injection of thermosetting polymeric materials with temperatures ranging from about 56° F. to about 160° F., under pressures that preferably range from about atmospheric pressure to about 500 psi. In another embodiment, the temperatures of the thermosetting polymeric material being injected into the card 1 will be between about 100° F. and about 120° F. under injection pressures that preferably range from about 80 to 120 psi. In one embodiment, the liquid or semi-liquid thermosetting polymeric material will be injected under these preferred temperature and pressure conditions at flow rates ranging from about 0.1 to about 70 grams/second.

Preferably, gates are employed that are tapered down from a relatively wide inflow area to a relatively narrow core region that ends at or near the leading edge(s) of the device being formed. Most preferably, these gates will narrow down from a relatively wide diameter (e.g., from about 5 to about 10 mm) injection port that is in fluid connection with the thermosetting material-supplying runner, to a relatively thin diameter (e.g., 0.10 mm) gate/device edge where the gate feeds the thermosetting material into the void space which ultimately becomes the center or core of the finished plastic card 1. Gates that taper from an initial diameter of about 7.0 millimeters down to a minimum diameter of about 0.13 mm will produce especially good results under the preferred cold, low-pressure injection conditions.

Another optional feature that can be used is the use of mold shells that have one or more receptacles for receiving “excess” polymeric material that may be purposely injected into the void space between the top 20 and bottom 10 layers in order to expunge any air and/or other gases (e.g., those gases formed by the exothermic chemical reactions that occur when the ingredients used to formulate most polymeric thermoset materials are mixed together) from said void space. These thermoset ingredients are preferably mixed just prior to (e.g., fractions of a second before) their injection into the void space.

After the injection of the thermosetting polymeric material, the molded structure is then removed from the injection molded apparatus. According to one embodiment of the invention, plastic cards 40 are cut out of one molded sheet 50. FIG. 4 depicts several plastic cards 40 formed on one sheet.

The finished plastic cards 1 are then removed from the excess polymeric materials (e.g., by triming them off of the precursor device body) and cut to certain prescribed sizes (e.g., 85.6 mm by 53.98 mm as per ISO Standard 7810) dependent upon the functionality and design parameters of the plastic cards 40. The trimming process may also remove the excess material in one cutting/trimming operation. It also will be well appreciated by those skilled in this art that the molding devices used to make such devices in commercial production operations will most preferably have mold shells having multiple cavities (e.g., 2,4, 6, 8, etc.) for making several such devices simultaneously.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A plastic card, comprising:
a bottom overlay;
a top overlay positioned above a top surface of the bottom overlay, wherein the top overlay or bottom overlay may have one or more protrusions; and
a core layer positioned between the top surface of the bottom overlay and the top overlay.

2. The plastic card, as claimed in claim 1, wherein the top overlay and bottom overlay are comprised of one of polycarbonate, polyvinyl chloride (PVC), polyethylene terephtalate (PET), or polyethylene terephtalate glycol (PETG).

3. The plastic card, as claimed in claim 1, wherein the core layer is thermosetting polymeric material.

4. The plastic card, as claimed in claim 1, wherein the core layer is comprised of polyurea.

5. The plastic card, as claimed in claim 1, wherein a thickness of a first portion of the plastic card is greater than or less than a second portion of the plastic card.

6. The plastic card, as claimed in claim 1, wherein the top overlay and bottom overlay are comprised of fabric.

7. The plastic card, as claimed in claim 1, wherein the one or more protrusions can be arranged to form a design.

8. The plastic card, as claimed in claim 1, wherein the top overlay and bottom overlay are comprised of any material configured to prohibit the core layer from penetrating through the top overlay or bottom overlay.

9. A method for manufacturing a plastic card, comprising:
loading a bottom overlay into an injection molding apparatus;
loading a top overlay into the injection molding apparatus wherein the top overlay is positioned above a top surface of the bottom overlay; and
injecting a core layer between the bottom overlay and top overlay, wherein one or more protrusions may be formed on the surface of the bottom overlay or top overlay.

10. The method of claim 9, further comprising removing top overlay and bottom overlay having an injected core layer from the injection molding apparatus and cutting out the plastic card.

11. The method of claim 9, wherein the core layer is thermosetting polymeric material.

12. The method of claim 9, wherein the core layer is polyurea.

13. The method of claim 9, wherein the top overlay and bottom overlay are comprised of one of polycarbonate, polyvinyl chloride (PVC), polyethylene terephtalate (PET), or polyethylene terephtalate glycol (PETG).

14. The method of claim 9, wherein the one or more protrusions can be arranged to form a design.

15. The method of claim 9, wherein the top overlay and bottom overlay are comprised of fabric.

16. The method of claim 9, wherein the top overlay and bottom overlay are comprised of any material configured to prohibit the core layer from penetrating through the top overlay or bottom overlay.

17. The method of claim 9, wherein the core layer is injected at a temperature of at most 150° F.

18. The method of claim 9, wherein the core layer is injected at a pressure of less than 2500 psi.

19. A plastic card, comprising:
a bottom overlay;
a top overlay positioned above a top surface of the bottom overlay; and
a core layer positioned between the top surface of the bottom overlay and the top overlay.

20. The plastic card, as claimed in claim 19, wherein the top overlay and bottom overlay are comprised of one of polycarbonate, polyvinyl chloride (PVC), polyethylene terephtalate (PET), or polyethylene terephtalate glycol (PETG).

21. The plastic card, as claimed in claim 19, wherein the core layer is thermosetting polymeric material.

22. The plastic card, as claimed in claim 19, wherein the core layer is comprised of polyurea.

23. The plastic card, as claimed in claim 19, wherein a thickness of a first portion of the plastic card is greater than or less than a second portion of the plastic card.

24. The plastic card, as claimed in claim 19, wherein the top overlay and bottom overlay are comprised of fabric.

25. The plastic card, as claimed in claim 19, wherein the top overlay and bottom overlay are comprised of any material configured to prohibit the core layer from penetrating through the top overlay or bottom overlay.

26. A method for manufacturing a plastic card, comprising:
loading a bottom overlay into an injection molding apparatus;
loading a top overlay into the injection molding apparatus wherein the top overlay is positioned above a top surface of the bottom overlay; and
injecting a core layer between the bottom overlay and top overlay.

27. The method of claim 26, further comprising removing top overlay and bottom overlay having an injected core layer from the injection molding apparatus and cutting out the plastic card.

28. The method of claim 26, wherein the core layer is thermosetting polymeric material.

29. The method of claim 26, wherein the core layer is polyurea.

30. The method of claim 26, wherein the top overlay and bottom overlay are comprised of one of polycarbonate, polyvinyl chloride (PVC), polyethylene terephtalate (PET), or polyethylene terephtalate glycol (PETG).

31. The method of claim 26, wherein the top overlay and bottom overlay are comprised of fabric.

32. The method of claim 26, wherein the top overlay and bottom overlay are comprised of any material configured to prohibit the core layer from penetrating through the top overlay or bottom overlay.

33. The method of claim 26, wherein the core layer is injected at a temperature of at most 150° F.

34. The method of claim 26, wherein the core layer is injected at a pressure of less than 2500 psi.
